(19) United States
(12) Patent Application Publication
(10) Pub. No.: US 2003/0130934 A1
(43) Pub. Date: Jul. 10, 2003

(54) Interactive system for providing cash flow-based interest rate quotations

(76) Inventor: Gregory S. Saunders, Greenbrae, CA (US)

Correspondence Address: Todd A. Noah, Dergosits & Noah LLP, Suite 1450, Four Embarcadero Center, San Francisco, CA, 94111, US

(21) Appl. No.: 10/039,535

(22) Filed: Jan. 4, 2002

(51) Int. Cl. G06F 17/60

(52) U.S. Cl. 705/38

(57) ABSTRACT

A network-based, interactive system for providing cash flow-based interest rate quotes is described. In accordance with embodiments of the present invention, an online system is implemented that allow borrowers and correspondent lenders to request cash flow-based interest quotes. An automated, interactive process is provided whereby a cash flow-based interest rate quote is requested, generated, and displayed to a user. The user is prompted to enter specific variables. These specific variables are pre-established by the lender. Other variables, parameters and matrices are provided and maintained by the lender as part of the system. The system includes a mathematical algorithm that utilizes the variables established by the user and the lender. This algorithm then determines the cash flow-based interest rate quote based on the specific variables provided by the user.

### FIELD OF THE INVENTION

The present invention relates generally to commercial mortgage quotation systems, and more specifically to a network-based system for providing cash flow-based interest rate quotations.

### BACKGROUND OF THE INVENTION

The determination of an appropriate interest rate for prospective borrowers is a crucial process in the field of commercial money lending. Various different factors are taken into account by lenders when quoting interest rates to prospective borrowers and correspondent lenders. For commercial mortgages, which are mortgages secured by real property that is income generating, one of the most important factors is the Debt Service Coverage Ratio (DSCR). This ratio is defined the net cash flow or net operating income of the property divided by the total debt service. The net operating income is the income from a rental property that remains after all of the operating expenses have been paid. The net cash flow is the operating income less tenant improvement costs, leasing commissions, capital expenditures, and other costs customarily included by the commercial mortgage industry. The total debt service includes the principal and interest payments of all loans on the property.

The higher the DSCR, the more net operating income is available to service the debt. A lender typically desires as high a DSCR as possible, and in general this ratio should be greater than one-to-one because it means the property is generating enough income to pay its debt obligations. A borrower, on the other hand, typically wants as large a loan as possible, but the larger the loan, the higher the debt service (mortgage payments). If the net operating income stays the same and the loan size (and therefore the debt service) increases, the DSCR decreases. Various lending companies and financial institutions have different DSCR requirements. For example, life insurance companies generally require a conservative 1.25 or 1.35 DSCR, which generally corresponds to low loan-to-value ratios. Savings and Loans institutions generally require only a 1.20 DSCR, and will sometimes accept a DSCR as low as 1.10. A DSCR of 1.0 is referred to as a break-even cash flow because the net cash flow or net operating income (NOI) is just enough to cover the mortgage payments (debt service).

Various factors regarding the borrower also impact the size and interest rate for a loan. For example, the credit history of a borrower, as well as his or her financial status and perceived ability to pay back a loan are factors that greatly determine a borrower's eligibility for a loan and the price, in terms of interest rate, of the loan.

Present methods of providing interest rate quotations are generally manual methods in which loan company or bank personnel use the DSCR to visually identify an appropriate interest rate published on a pricing grid. Such a pricing grid is typically an industry standard matrix of recommended interest rates or spreads corresponding to specific DSCR values, and may be published periodically and made available to interested lenders. Interest rates can be determined and quoted based on various different loan and borrower parameters. One popular type of interest rate quotation is the cash flow-based interest rate in which the interest rate is determined or estimated by a lender based primarily upon the amount of a property's net cash flow relative to the loan payment amount (i.e., DSCR). In general, as net cash flow increases relative to the loan payment, the interest rate decreases. A disadvantage of present cash flow-based interest rate quotation systems is that by relying on an interest rate provided by a published rate sheet, the quoted rate is static, and does not take into consideration the dynamic nature of the relationship between the interest rate, loan size, property type, and net cash flow. Furthermore, the absence of a computer network application to provide cash flow-based loan quotations impairs a lender's ability to quickly and efficiently deliver interest rate quotations to its borrowers or prospective borrowers.

What is needed, therefore, is an improvement over present manual methods of providing loan quotations that rely on the visual identification of appropriate interest rates published on a pricing grid based on DSCR values. This is provided by a loan application and interest rate quotation system that automates the calculation of a cash flow-based interest rate so as to materially resolve the circular reference inherent in the determination of a cash flow-based interest rate. This circular reference exists because the DSCR is dependent upon the loan payment amount, which is dependent upon the loan interest rate, which, in turn, is ultimately dependent on the DSCR (for cash flow-based interest rates).

### SUMMARY OF THE PRESENT INVENTION

A network-based, interactive system for providing cash flow-based interest rate quotes is described. In accordance with embodiments of the present invention, an online system is implemented that allow borrowers or correspondent lenders to request and receive instant cash flow-based interest rate quotes. An automated, interactive process is provided whereby a cash flow-based interest rate quote is requested, generated, and displayed to a user. The user is prompted to enter specific variables. These specific variables are established by the lender. The system includes a mathematical algorithm engine that utilizes the variables established by the borrower and the lender. This engine then determines the cash flow-based interest rate to quote based on the specific variables provided by the user.

Other features and advantages of the present invention will be apparent from the accompanying drawings and from detailed description that follows.

### BRIEF DESCRIPTION OF THE DRAWINGS

The present invention is illustrated by way of example and not limitation in the figures of the accompanying drawings, in which like references indicate similar elements, and in which:

FIG. 1 illustrates a computer network that includes a client computer coupled to one or more server computers that may be used to implement embodiments of the present invention;

FIG. 2 is a flowchart that illustrates the interactive loan quotation system, according to one embodiment of the present invention;

FIG. 3 is a more detailed flowchart illustrating specific process steps for the method illustrated in FIG. 2;

FIG. 4 illustrates an exemplary table of entries for various Loan to Value (LTV) ratios and the associated spread values;

FIG. 5 illustrates an exemplary table of entries for various Debt Service Coverage Ratios (DSCR) and the associated spread values; and

FIG. 6 illustrates an exemplary input page that can be displayed on the client computer of FIG. 1.

### DESCRIPTION OF THE PREFERRED EMBODIMENTS

A cash flow-based interest rate quotation system for online loan applications is described. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of preferred embodiments is not intended to limit the scope of the claims appended hereto.

Hardware Overview

Aspects of the present invention may be implemented on one or more computers executing software instructions. According to one embodiment of the present invention, server and client computer systems transmit and receive data over a computer network or standard telephone line. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the downloaded instructions may be directly supported by the CPU. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers.

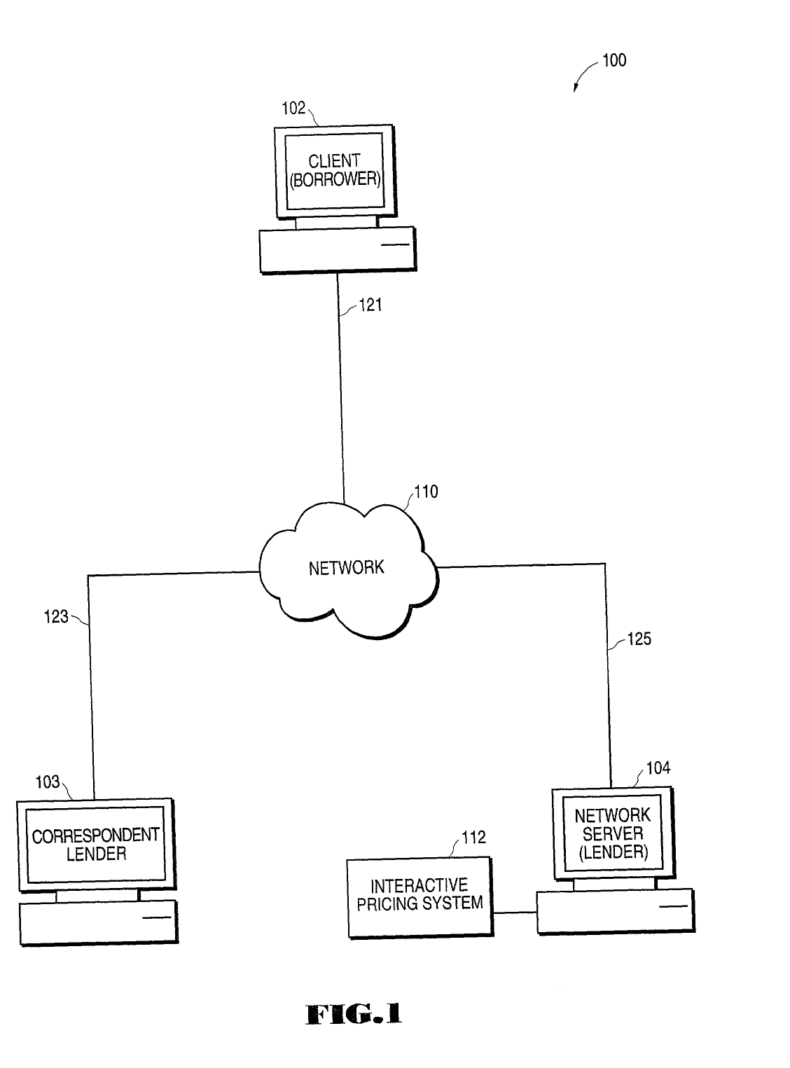

FIG. 1 illustrates a computer network system 100 that implements one or more embodiments of the present invention. In system 100, a network server computer 104 is coupled, directly or indirectly, over line 125 to one or more network client computers, such as client 102 through a network 110. The network interface between server computer 104 and client computer 102 may also include one or more routers that serve to buffer and route the data transmitted between the server and client computers over lines 121 and/or 125. Network 110 may be the Internet, a Wide Area Network (WAN), a Local Area Network (LAN), or any combination thereof.

In one embodiment of the present invention, the server computer 104 is a World-Wide Web (WWW) server that stores data in the form of ‘web pages’ and transmits these pages as Hypertext Markup Language (HTML) files over the Internet network 110 to the client computer 102. For this embodiment, the client computer 102 typically runs a “web browser” program (not shown) to access the web pages served by server computer 104 and other content provider computers coupled to the network 110.

In one embodiment of the present invention, server 104 in network system 100 is a server that contains an interactive pricing system 112, which includes an interest rate quotation program. Client versions of the interest rate quote program may also be executed on the client computers, such as client computer 102, or the processes provided by the program may be executed on the server with appropriate data downloaded to the client computer.

The interactive pricing system 112 may represent one or more executable program modules that are stored within network server 104 and executed locally within the server. Alternatively, however, it may be stored on a remote storage or processing device coupled to server 104 or network 110 and accessed by server 104 to be locally executed. In a further alternative embodiment of the present invention, the interactive pricing system 112 may be implemented in a plurality of different program modules, each of which may be executed by two or more distributed server computers coupled to each other, or to network 110 separately.

In one embodiment of the present invention, wherein network 110 is the Internet, network server 104 executes a web server process to provide HTML documents to client computers coupled to network 110. To access the HTML files provided by server 104, client computer 102 runs a web client process (typically a web browser, such as Netscape Navigator™ or Microsoft Explorer™) that accesses and provides links to web pages available on server 104 and other Internet server sites. It should be noted that a network system 100 that implements embodiments of the present invention may include a larger number of interconnected client and server computers than shown in FIG. 1. For this embodiment, the client computer 102 may access the Internet network 110 through an Internet Service Provider (ISP).

In one embodiment of the present invention, client 102 represents a client computer operated by a user (also referred to as “customer,” “borrower,” or “correspondent lender”) who is interested in obtaining a loan or arranging the financing of a loan. Server 104 is a server computer that is operated by a lender, such as a bank or financial institution that provides loans to users directly and/or through correspondent lenders. In an alternative embodiment, the server computer may be operated by a third party that executes the loan interest rate program on behalf of a bank or finance company that maintains a presence on the network 110 through a separate server computer. For this embodiment, a server computer 103 may be maintained by a correspondent lender that arranges the financing of a prospective loan or commercial real estate loan for a borrower, such as a commercial bank, mortgage bank, or broker.

As can be appreciated by those of ordinary skill in the art, the representative networked computers of FIG. 1, such as network server computer 104 can be implemented as any standard computer that includes a CPU coupled through a bus to various other devices. These devices could include random access memory (RAM), a read only memory (ROM), and mass storage devices (e.g., a magnetic disk, optical compact disk, or tape drive for storing data and instructions). The computer also typically includes input/output devices, such as, a display device, keyboard, and network interface device, along with other similar devices or interfaces. Any of the computers in FIG. 1 could be implemented in the form of personal computers, laptop computers, handheld computing devices, mainframe computers, or other type of workstation computers.

For the embodiment illustrated in FIG. 1, online interest rate quotes are provided for borrowers or correspondent lenders by a server system coupling a lender, such as a bank or other financial institution to the one or more users through a network, such as the Internet. It is assumed that the borrowers are interested in obtaining commercial mortgages, and that correspondent lenders are interested in arranging the commercial mortgages. A commercial mortgage is a mortgage secured by real property that is income-generating property. Such property could include single-family, multi-family and commercial real estate properties.

Interactive Loan Quotation Process

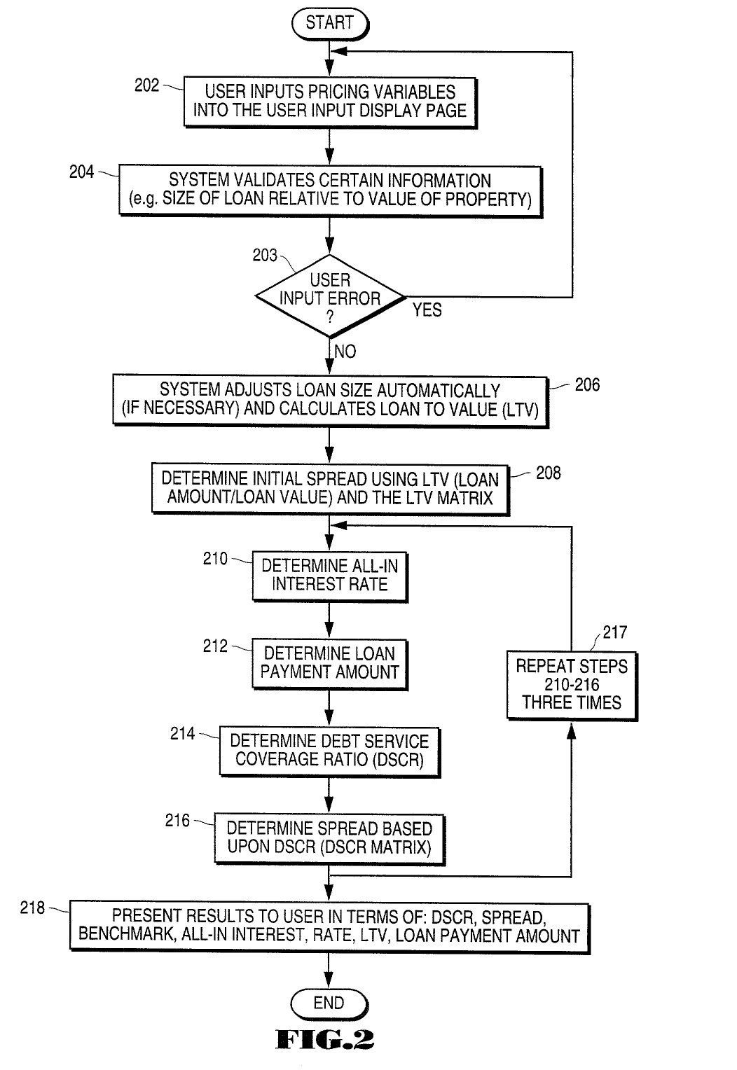

In one embodiment of the present invention, the loan interest rate quotation program within the interactive pricing system 12 is an interactive program that takes certain input from the user and specific variables pre-determined by the lender. It then processes the user information and loan amount information using an iterative sequence of steps to determine an appropriate interest rate for the requested loan amount. FIG. 2 is a high-level flowchart that illustrates the loan quotation program of the interactive pricing system, according to one embodiment of the present invention. The flowchart of FIG. 2 illustrates the general process steps that are executed in a computer-implemented method embodied within the system illustrated in FIG. 1. The software program for implementing these process steps can be locally resident or distributed on either the client 102 or server 104 computers, or on other storage locations coupled to network 110. The method steps embodying the interactive pricing system 112 are typically executed locally or remotely on the server 104 computer as a server-side process. Alternatively, however, portions of the interactive pricing system may be executed on the client computer 102 as client-side processes.

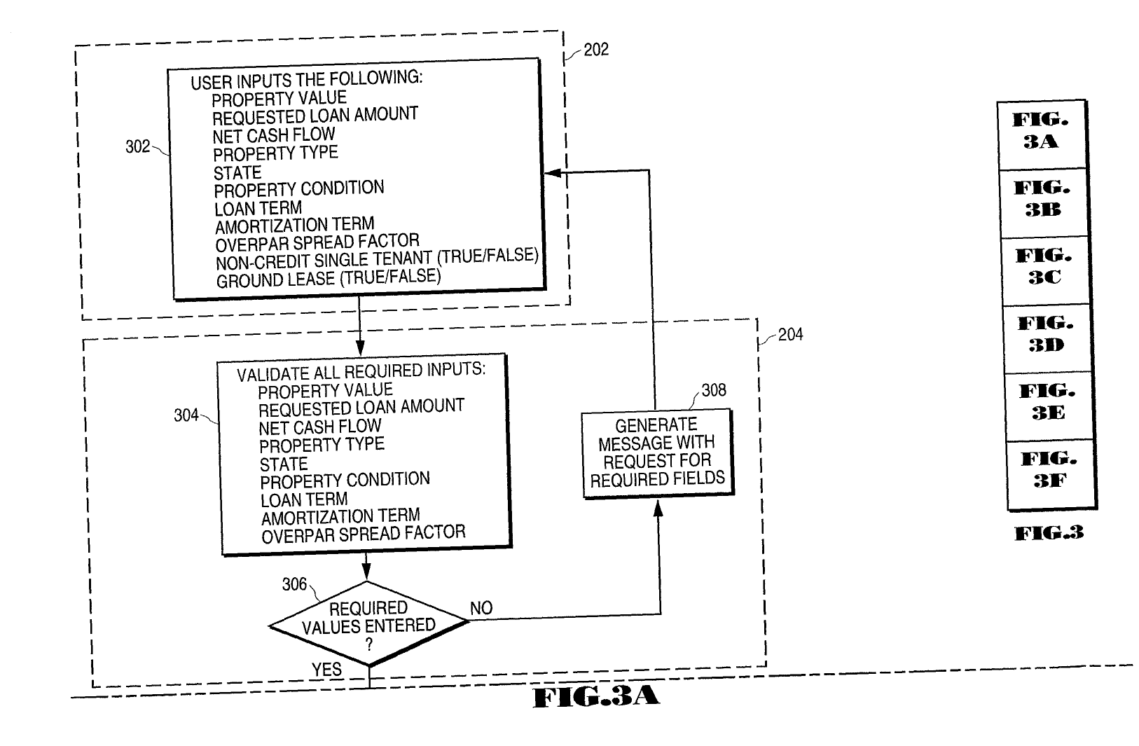

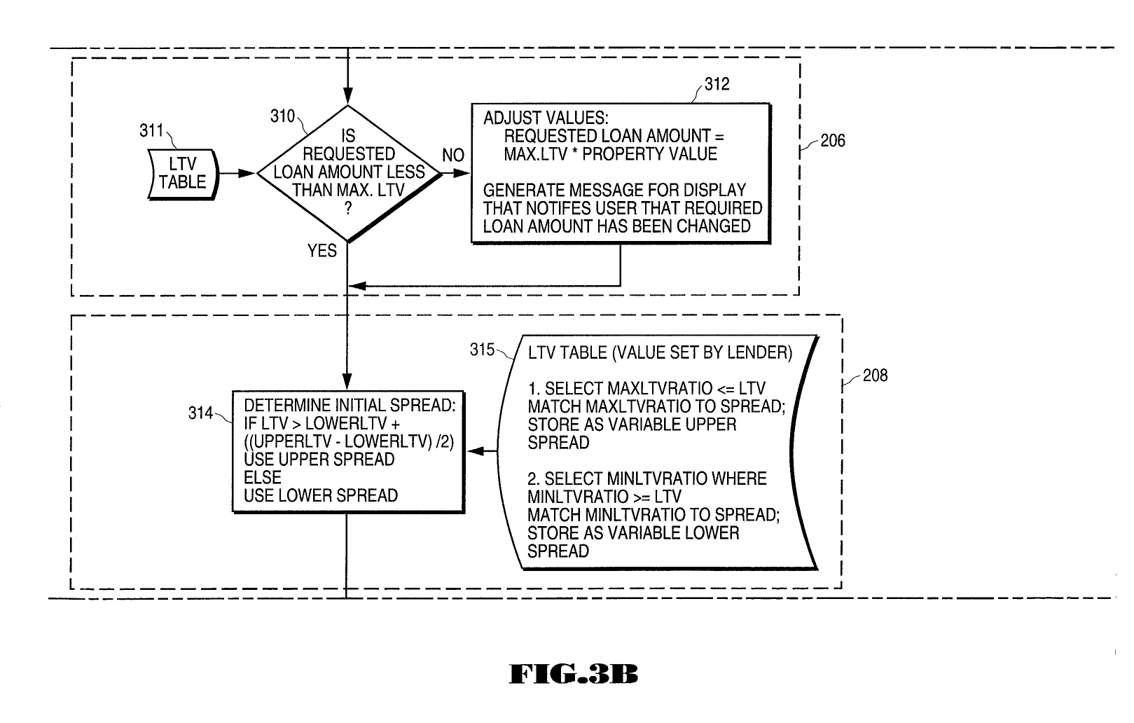

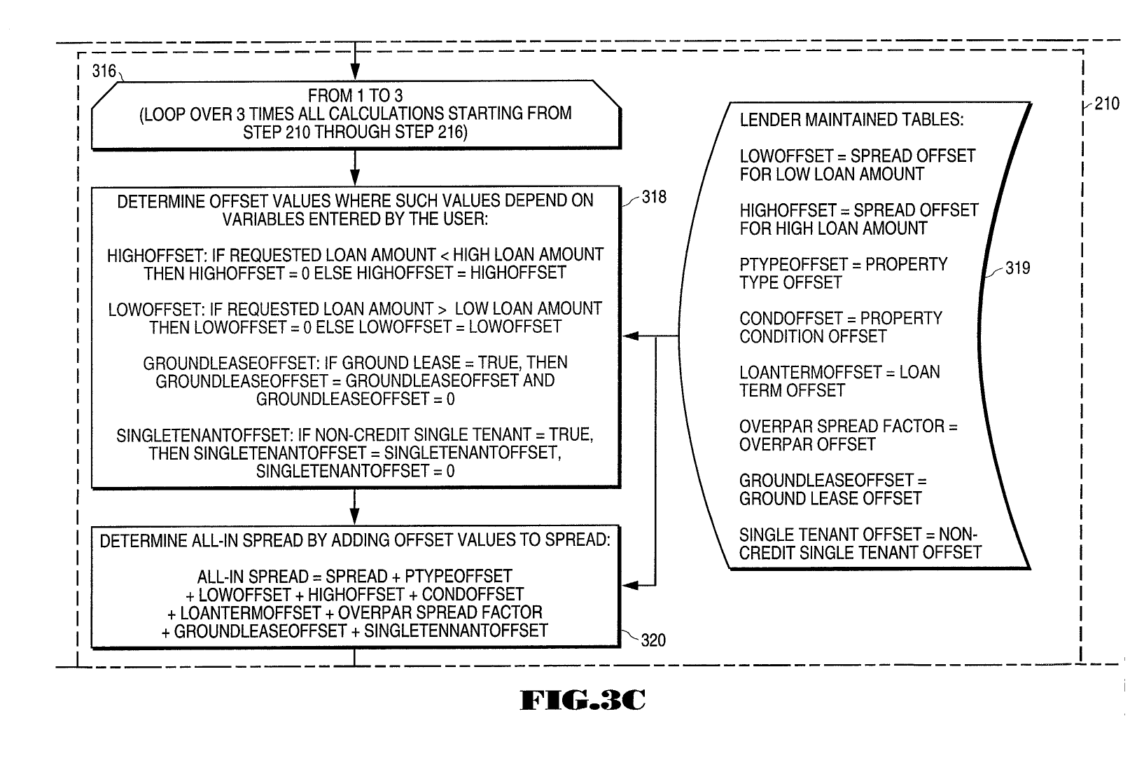

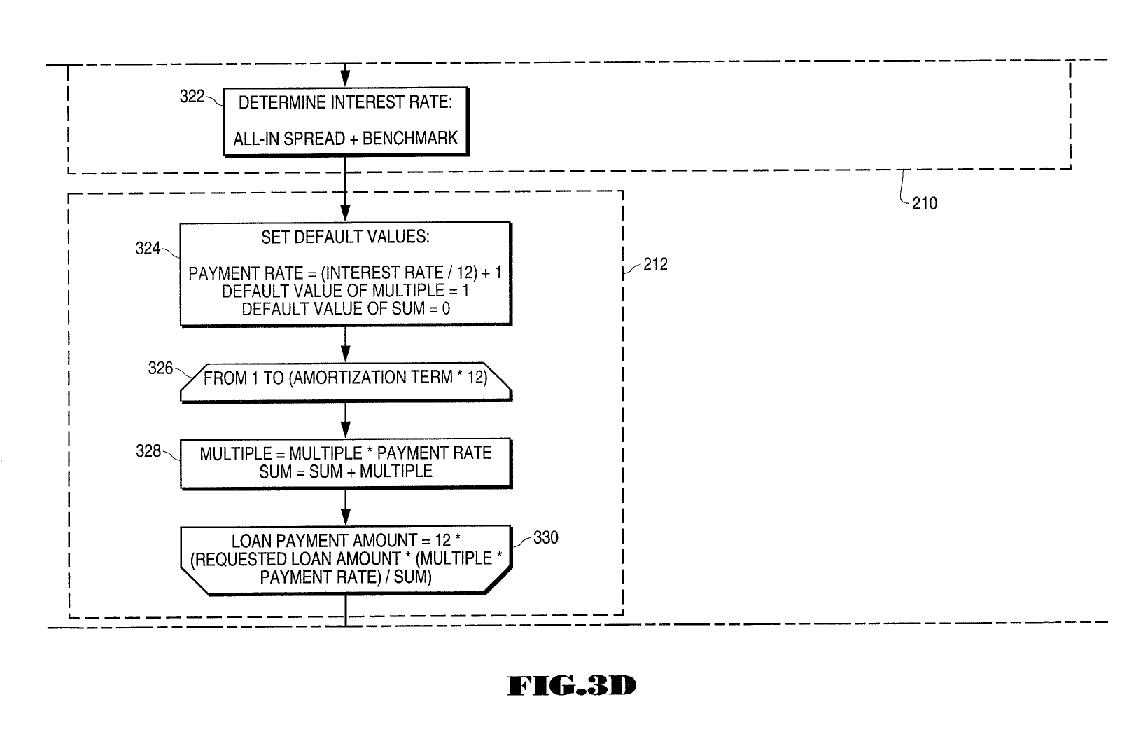

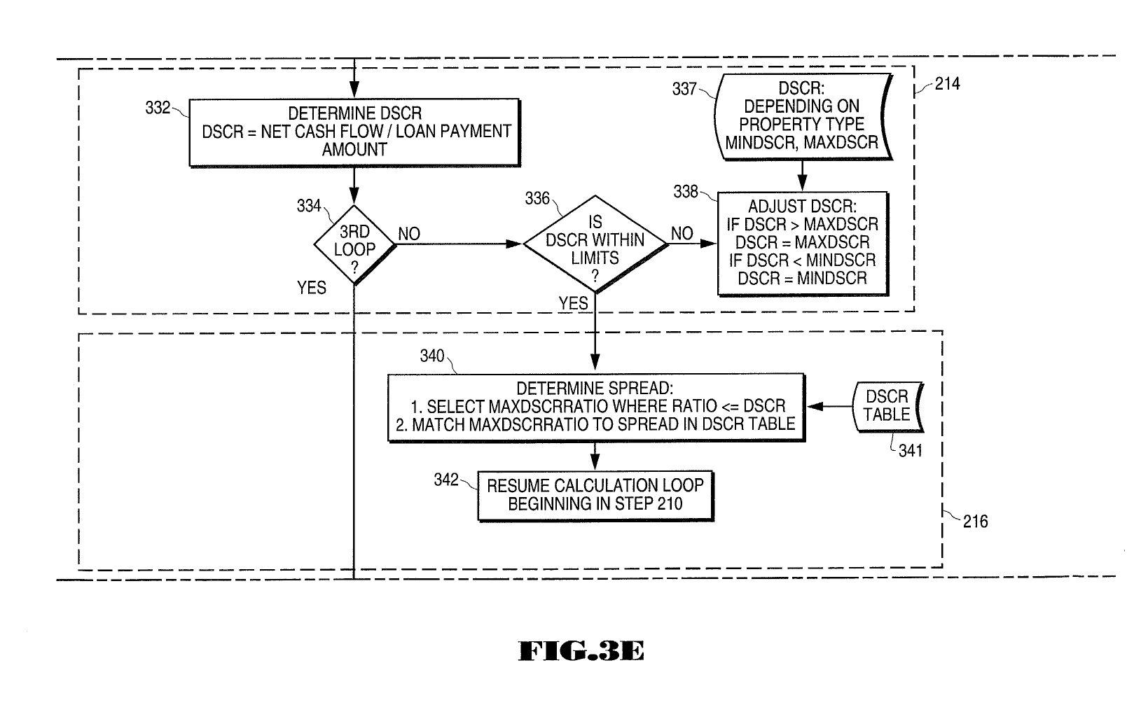

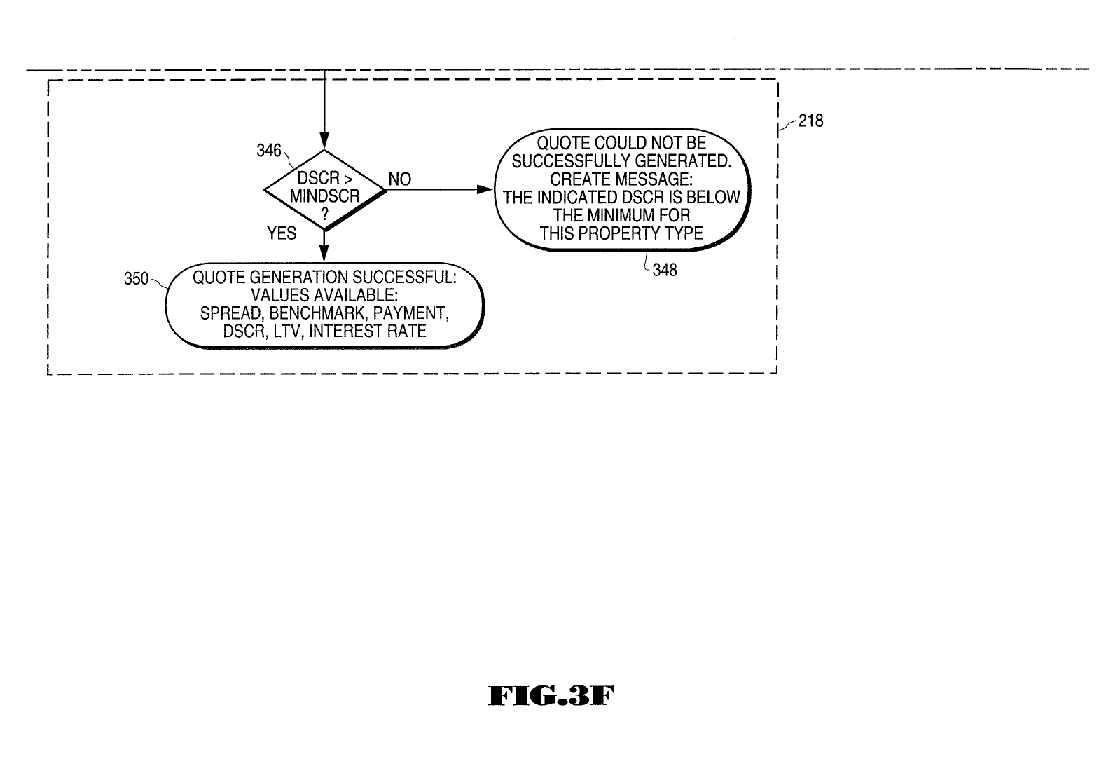

The interest rate quotation program prompts the user for the input of certain items of information regarding the requested loan and the property for which the loan is being obtained. The program then performs an iterative operation on the input data to calculate a cash flow-based interest rate. The flowchart of FIG. 2 illustrates the interactive pricing system in terms of high-level process steps. More detailed calculations and processes for each of the process steps of FIG. 2 are provided in the flowchart of FIG. 3.

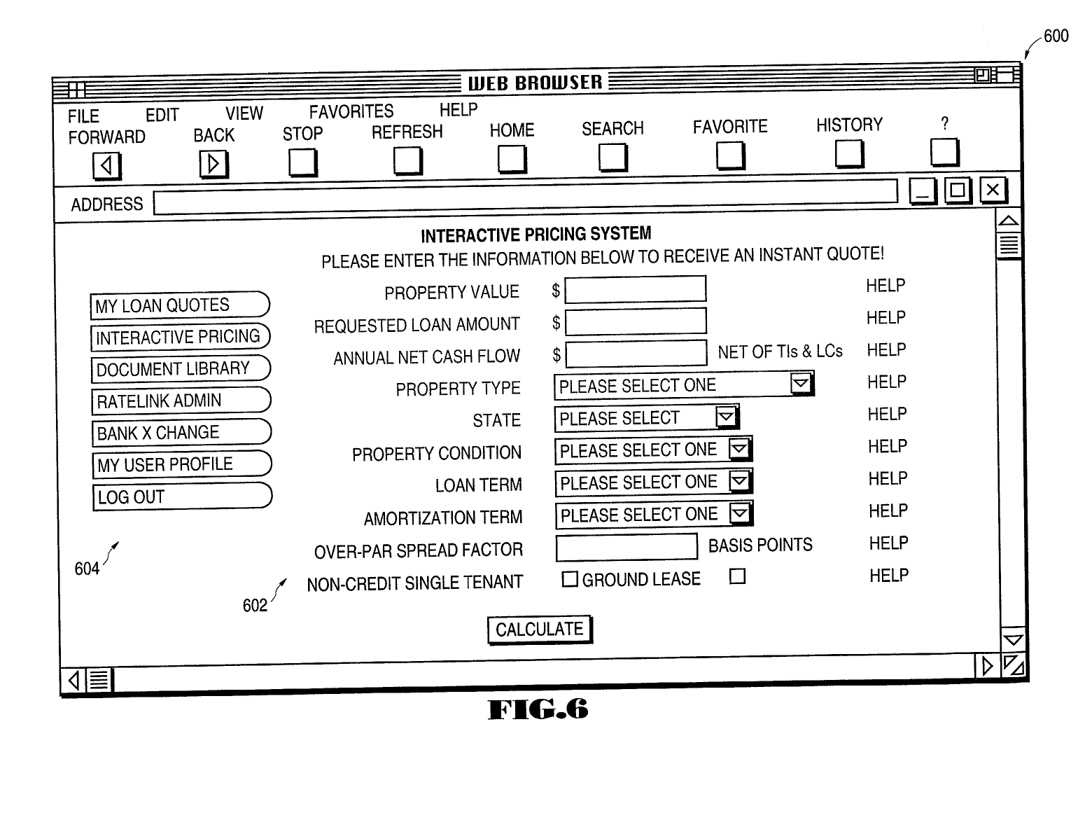

In step 202 of FIG. 2, the user inputs certain personal information and pricing variables into the system. In most cases, a user input page is provided over network 110 and displayed on the client computer 102. Typically, the loan interest rate quotation program 112 is embodied in a web-based implementation in which the network server 104 executes a web server process to provide a user interface for the loan application system to a user through a web browser running on client computer 102 via the Internet 110. FIG. 6 illustrates an exemplary user input web page that is served by the server 104 and displayed through the web browser of the client computer. This web page provides various data input fields that allow the user to enter relevant data related to the loan and the property. Web page 600 represents an exemplary “home” page that provides a user interface into the interactive pricing system 112 maintained by server 104. This page provides access to various functions 604 of the system, as well as text input fields 602 that allows the user to specify various items of information that are used by the system to generate an interest rate quote for a commercial loan. Various items of information are requested regarding the requested loan and the property involved in the loan. As shown in input fields 602, this information includes items such as property value, requested loan amount, cash flow, and so on. In certain applications, a correspondent lender 103 may arrange financing of the prospective loan for the user. In this case, the user may enter an over-par spread factor into appropriate field of the user input page 600. A more detailed description of each user input field is provided below in reference to the flowchart of FIG. 3.

With reference to FIG. 2, after the user inputs the requested data in step 202, the system validates the input information by checking that all required input items are provided and that the values are within acceptable ranges, step 204. Step 203 checks for user input errors. Missing or invalid information is then provided or corrected by the user. If certain values are out of range (as pre-determined and maintained in the system by the lender), such as the size of the requested loan exceeds the value of the property, these values are adjusted accordingly so that the requested loan value is within an acceptable range, step 206. In step 206, the Loan to Value (LTV) ratio is also determined. The LTV ratio is the requested loan amount divided by the indicated property value. In step 208, the initial spread is determined using the LTV ratio to identify a spread value from an LTV matrix or price grid that is accessed by the system and is entered into the system and updated from time to time as needed by the lender. The initial spread represents the lender's “risk premium” over a benchmark base interest rate or yield, where the risk includes credit and/or economic risk.

In step 210 the all-in interest rate is determined. The all-in interest rate comprises the benchmark plus the all-in spread. The benchmark is a base yield that is typically the yield on a comparable maturity U.S. Treasury Note or Bond. The all-in spread is the spread representing the lender's required margin over the benchmark plus certain offset values that factor in information related to the user, the property, and the loan. The loan payment amount is then determined in step 212. This is the annualized amount of principal and interest payable by the prospective borrower with respect to the prospective loan. It is determined by a mathematical routine that is based upon the loan amortization term, requested loan amount, and the interest rate. In step 214, the Debt Service Coverage Ratio (DSCR) is determined. This is the net cash flow generated by the subject property on an annual basis, divided by the annualized amount of principal and interest payments of the prospective loan. Next, the spread based upon the DSCR is determined, step 216. This is determined through the use of a DSCR table that sets forth an array of DSCR values, by property type, and their related spreads. Typically, this table is established and entered into, or otherwise made available to the system by the lender, and may be updated from time to time as needed.

The interactive pricing system 112 is an iterative process that materially resolves the circular reference inherent in the determination of a cash flow-based interest rate. The circular reference results from the fact that, for cash flow-based interest rates, the DSCR is dependent upon the loan payment amount, which is dependent upon the loan interest rate, which, in turn, is dependent on the DSCR. As illustrated in FIG. 2, the process steps 210 through 216 of determining the all-in interest rate, loan payment amount, DSCR, and DSCR spread is repeated a number of times (e.g., three times) in a processing loop 217. The continued iteration of this calculation results in a marginal change of the DSCR value of less than 0.1% in typical applications after the execution of the final loop. In certain embodiments, the system may be programmed so that the calculation is performed in a loop of greater than three iterations; however, processing time and expense typically increases relative to decreased marginal change of the DSCR value with each extra iteration.

Once the iterative loop 217 has been executed, the results are presented to the user, step 218. In one embodiment, the system and generates the DSCR value, spread, benchmark, interest rate, LTV and loan payment amount information to the user. Other items deemed appropriate by the lender can also be generated and transmitted to the user. One such value may be an overpar value that represents the prospective dollar amount that a correspondent lender, such as correspondent lender 103 in FIG. 1, may earn for arranging a prospective loan, for embodiments in which a correspondent lender arranges the financing of the prospective loan for a borrower. In general, as described above, a correspondent lender is a third-party lender who arranges the financing of a prospective loan or commercial real estate loan for a borrower.

Each step of the flowchart illustrated in FIG. 2 comprises a number of sub-steps that involve the derivation and calculation of different parameters and values. FIG. 3 is a flowchart that illustrates the interactive pricing process of FIG. 2 in greater detail with regard to specific sub-steps within each process step. For the sake of illustration, the major process steps of FIG. 2 are represented in FIG. 3 as dashed boxes with the associated sub-steps further delineated.

The process shown in FIG. 3 begins in step 302 when the user inputs the following requested data: property value, requested loan amount, net cash flow, property type, state, property condition, loan term, amortization term, overpar spread factor, tenant status, and lease status. The property value is the market value, either estimated or actual, of the real property to be secured by a commercial mortgage, and the requested loan amount is the dollar amount of the prospective loan. In most cases, the prospective loan will be a commercial mortgage that has not yet been financed, but the possible terms and conditions of which are being negotiated by the prospective borrower, lender, and/or correspondent lender. The net cash flow is the estimated or actual sum of the annual values of all property net revenues, less all property operating expenses and reserves. The property type is a classification as to the type of commercial property; examples of property types include multi-family, industrial, retail, and so on. State refers to the state in which the property is located, and the property condition describes the physical condition of the property, e.g., good, excellent, and so on. The loan term is the number of years before a commercial mortgage becomes fully due and payable to the lender, and the amortization term is the term in years over which the principal of a prospective loan or real estate loan is amortized.

The overpar spread factor is stated in basis points and represents a correspondent lender's additional premium that is added to a spread in order to determine the all-in-spread and interest rate. In general, a basis point is one hundredth of a percent (0.01%), and is a value that is used to measure changes in or differences between yields or interest rates, where a “point” is one percent of the loan amount. Here, the spread is an amount that represents a lender's margin over a benchmark that meets or exceeds such party's risk and return parameters with respect to financing a prospective loan. As stated above, a benchmark is a base interest rate or yield, typically the yield on the comparable maturity U.S. Treasury note or bond, to which the all-in spread is added to determine the interest rate. The all-in spread is a spread factor that is calculated through various spread and offset values by the interest rate quotation program, as will described in more detail below.

As shown in step 302, the user also inputs two true/false status values. The first, tenant status refers to a tenant of a property who is the single tenant and carries no credit rating through the major credit rating agencies, or has a credit rating that is considered non-investment grade. The user enters “true” if the property has a non-credit single tenant. The second true/false entry is the ground lease status. The user enters “true” if the property is subject to a ground lease. In an online, web-based embodiment of the interactive pricing system 112, the user may input the requested values into a web page such as that illustrated in FIG. 6. Some of the input values provided in step 302 may be provided directly by the user, such as property value, requested loan amount, and so on, while others may be provided by the system. System provided information can include the overpar spread multiple (provided by the lender as a variable into the system), which is used in calculating prospective fees for a correspondent lender who arranges financing of the loan. The output provided to the user displays an overpar fee which is the product of the loan amount times the overpar spread multiple times the overpar spread factor (divided by 10,000).

In step 304, the system validates the input values provided by the user in step 302 to ensure that all required input data items are provided. All input values are validated except for the tenant status and ground lease status true/false input items. In step 306 it is determined whether all of the required values are entered. If not, a message is generated that prompts the user to provide input data for the required fields, step 308. Once all input data is provided by the user, the system determines whether the requested loan amount is less than the maximum loan to value (LTV) ratio, step 310. The maximum LTV ratio for a given property depends upon the property type and is a variable that is typically provided by the lender in the form of an LTV table 311 that sets forth an array of LTV values and related spreads for any property type. This table is established and entered into, or otherwise made accessible to the system by the lender. It may be updated from time to time as needed. If it is determined, in step 310, that the requested loan amount results in an LTV that is greater than the maximum LTV, the requested loan amount value is automatically adjusted so that the requested loan amount equals the property value multiplied by the maximum LTV value. The process then generates and transmits a message to the user alerting him that the required loan amount has been changed, step 312.

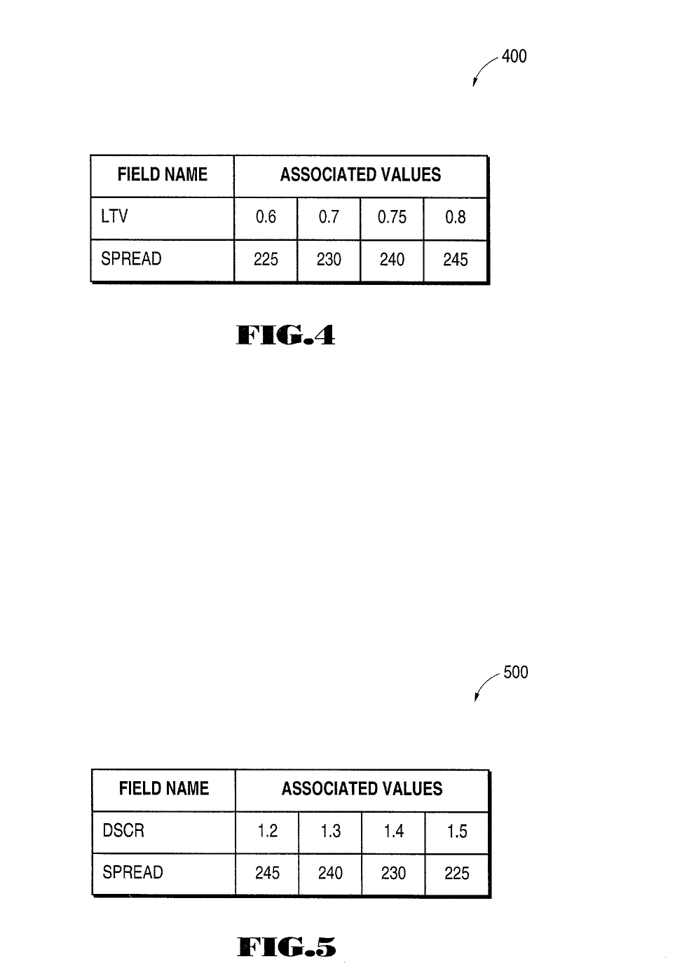

If the LTV (calculated using the requested loan amount) is less than the maximum LTV, the system then determines the initial spread value, step 314. The initial spread is determined in relation to the LTV values provided in the LTV table 311 and is first calculated by locating the value associated with the LTV value within the LTV table for a given property type. Process step 315 provides the appropriate values from the LTV table 211 to the process executed in step 314. Step 314 returns a spread that is determined relative to an upper spread variable value or a lower spread variable value as stored by step 315. The upper spread variable is defined as the spread value that corresponds to the maximum LTV ratio (MaxLTVRatio), i.e., the LTV ratio most closely stated in the LTV table that is the next higher LTV value relative to the spread. The lower spread variable is defined by the spread value that corresponds to the minimum LTV ratio (MinLTVRatio), i.e., the LTV ratio stated in the LTV table that is the next lower LTV value relative to the spread. The MaxLTVRatio value is the closest LTV value within the array of LTV values in the LTV table 311 that is less than or equal to the LTV. The MinLTVRatio is the closest LTV value within the array of LTV values in the LTV table 311 that is greater than or equal to the LTV. FIG. 4 illustrates an exemplary table of entries for various LTV ratios and the associated spread values. As shown in table 400, an LTV ratio of 0.6 corresponds to a spread of 225, an LTV of 0.7 corresponds to a spread of 230, and so on. Table 400 is provided for purposes of illustration, and the actual LTV table 311 will typically contain a much larger array of LTV ratios and associated spread values.

As illustrated in step 315, the spread value corresponding to the MaxLTVRatio is stored as the upper spread variable, and the spread value corresponding to the MinLTVRatio is stored as the lower spread variable. Thus, using table 400 in FIG. 4 as an example, if the LTV is 0.62, the MaxLTVRatio would be 0.6 and the MinLTVRatio would be 0.7. In this case, the upper spread variable would be assigned a value of 225 and the lower spread variable would be assigned a value of 230.

Once the upper and lower spread values are determined by step 315, the initial spread is determined in step 314. To calculate the initial spread, the system compares the LTV to a value defined by the upper and lower LTV values in the LTV table. The lower LTV value (LowerLTV) is the lowest LTV value for a given property type in the LTV table, and the upper LTV value (UpperLTV) is the highest LTV value for a given property type in the LTV table. In step 314 it is determined whether the LTV is greater than the sum of the LowerLTV value and one-half the difference between the UpperLTV and LowerLTV values. If the LTV is greater than this sum, then the initial spread is defined as the upper spread derived in step 315; if the LTV is less than or equal to this sum, then the initial spread is defined by the lower spread derived in step 315.

Step 316 in FIG. 3 initiates the iterative process of determining the all-in interest rate, loan payment amount, DSCR, and DSCR spread through a finite (e.g., three iteration) loop process, as illustrated in steps 210 to 216 in FIG. 2.

With reference to FIG. 3, as shown in sub-step 320 of step 210, the all-in spread is calculated by adding various offset values to the spread. The all-in spread equals the spread plus the following offset values: property type (PtypeOffset) which is an offset value that reflects the property type, low offset (LowOffset) which is a variable that is added to the spread if the loan amount is less than the low loan amount, high offset (HighOffset) which is a variable that is added to the spread if the loan amount is greater than the high loan amount, condition offset (CondOffset) which is a value that reflects the condition of the property, loan term offset (LoanTermOffset) which is a variable reflecting the loan term, overpar spread factor (which represents a correspondent lender's potential additional fee income), ground lease offset (GroundLeaseOffset) which is a value added if the user has indicated that the property is subject to a ground lease, and single tenant offset (SingleTenantOffset) which is a value added if the user has indicated that the condition non-credit single tenant is true. The offset values used in steps 318 and 320 are provided to the system by one or more lender maintained tables 319.

Step 318 illustrates the derivation of some of the offset values used in step 320 for offsets that depend on variables entered by the user in step 302. For step 318, a high loan amount and a low loan amount are defined by the lender. These are used to test the size of the requested loan and represent the limits of the loan allowed by the lender. If the requested loan amount is less than the high loan amount, then the HighOffset value is set to zero, otherwise it is set to a value pre-specified by the lender. Likewise, if the requested loan amount is greater than the low loan amount, then the LowOffset value is set to zero, otherwise it is set to a value pre-specified by the lender. If the user indicates that the property is subject to a ground lease or if the single tenant status is true, than the corresponding GroundLeaseOffset and SingleTenantOffset values are set to values pre-determined by the lender, otherwise these values are set to zero. For offset values not derived in step 318, the values are determined by the lender, and may be updated periodically as necessary.

In sub-set 322 of step 210, the interest rate is calculated by adding the all-in spread to the benchmark. Thus, the interest rate determined by the system corresponds to the benchmark interest rate summed with the spread and the various offset values determined in step 318.

In step 212, the loan payment amount is determined. This step begins with sub-step 324 in which certain default values for calculation variables are set. These variables are denoted payment rate, multiple and sum. The default value for the payment rate variable is the monthly interest rate (annual interest rate divided by 12) plus one. The default value for the multiple variable is one, and that for the sum is zero.

Steps 326, 328, and 330 comprise a process loop to calculate the loan payment amount that is executed a number of times corresponding to the amortization term multiplied by 12. In step 328 of this loop, the multiple variable is assigned the value multiple times payment rate, and the sum variable is assigned the value sum plus multiple. In step 330, the loan payment amount is calculated from the following formula:

Loan Payment Amount=12*(Requested Loan Amount*(Multiple*Payment Rate)/Sum)

For the above equation, the default (initial) values for the Multiple, Payment Rate, and Sum variables are provided in step 324.

Once the loan payment amount is determined, the DSCR value is determined. In step 332, the DSCR is determined by dividing the net cash flow by the loan payment amount. As shown in step 316, the main loop of the process is executed three times. In step 334 it is determined whether the third iteration of the loop has been executed. If not, it is determined, in step 336 whether the calculated DSCR is within pre-defined limits defined by parameters MaxDSCR and MinDSCR, which are the maximum and minimum DSCR values for a given property type as defined by the lender, step 337. If the DSCR is not within these limits, the DSCR is adjusted, step 338. If the calculated DSCR is greater than the MaxDSCR, then the DSCR is set to the MaxDSCR value; likewise, if the calculated DSCR is less than the MinDSCR, then the DSCR is set to the Min DSCR value.

Once the DSCR is set to be within the limits, or if it was originally determined to be within the limits, the spread is determined, step 340. The spread is provided by a DSCR table 341 that is established and entered into the system, or otherwise made accessible to the system by the lender. The DSCR table sets forth an array of DSCR values and related spreads, and may be updated periodically, as needed. FIG. 5 illustrates an exemplary table of entries for various DSCR values and the associated spread values. As shown in table 500, a DSCR of 1.2 corresponds to a spread of 245, a DSCR of 1.3 corresponds to a spread of 240, and so on. Table 500 is provided for purposes of illustration, and the actual DSCR table 341 will typically contain a much larger array of DSCR values and associated spread values. In step 340, the spread value is selected to be the spread entry in the DSCR table that corresponds to the maximum DSCR (MaxDSCRatio) that is less than or equal to the DSCR value determined in step 214. Thus, for example, if the DSCR determined in step 214 is 1.27, the MaxDSCRatio determined in step 340 using the DSCR table 500 is 1.2. The corresponding spread for this ratio is 245, which would be the value returned in step 340. The process then repeats from step 210 until the number of iterated loops is completed.

Once the iterated number of loops is completed, as determined in step 334, the process proceeds to step 218 in which sub-step 346 first determines whether the DSCR calculated in step 332 is greater than the minimum DSCR value for the property type established by the lender. If the DSCR is not greater than or equal to this minimum value, the system returns a message to the user stating that the quote could not be successfully generated because the indicated DSCR is below the minimum for the particular property type, step 348. If the DSCR is greater than the minimum value, the system returns a message to the user stating that the quote was successfully generated, step 350. The system then returns a series of values to the user, such as the all-in spread, benchmark, loan payment, DSCR, LTV, and interest rate. Other parameters or items of information can also be returned to the user, if desired by the lender.

Although embodiments of the present invention have been described in relation to providing commercial mortgages, it should be understood that the present invention can also be applied to providing quotes for other types of commercial loans.

In the foregoing, a system has been described for providing online cash flow-based interest rate quotes for loan. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method of providing an online loan quotation from a lender to a user, the method comprising the steps of:
receiving input data from a borrower regarding a prospective loan and a property, the data including a requested loan amount, a property value and type, and borrower cash flow;
receiving an overpar spread factor representing a prospective fee for arranging the loan charged by a correspondent lender;
calculating a loan-to-value (LTV) for the requested loan by dividing the requested loan amount by the property value;
calculating an all-in spread value by adding one or more offset values to an initial spread value;
calculating an interest rate by adding the all-in spread value to a benchmark interest rate;
determining a debt service coverage ratio (DSCR) by dividing the user cash flow by a loan payment amount; and
comparing the calculated DSCR with a minimum DSCR for a corresponding property type in a published DSCR pricing grid.

2. The method of claim 1 further comprising the steps of:
transmitting a message to the user indicating that the loan quotation was successful if the calculated DSCR is greater than the minimum DSCR; and
transmitting a message to the user indicating that the loan quotation was not successful if the calculated DSCR is not greater than the minimum DSCR.

3. The method of claim 1 further comprising the steps of:
validating the input data received by the borrower after the step of receiving the input data;
comparing the calculated loan-to-value with a maximum loan-to-value for the borrower provided property type with a maximum loan-to-value for the property type in a lender-determined LTV pricing grid, and adjusting the requested loan amount if the calculated loan-to-value exceeds the maximum loan-to-value for the property type.

4. The method of claim 1 wherein the steps of calculating the all-in spread value, calculating the interest rate, and determining the debt service coverage ratio are executed in a loop performed a plurality of times, and wherein the method further comprises the steps of:
comparing the calculated DSCR to a minimum DSCR value and maximum DSCR value provided in the DSCR pricing grid;
adjusting the calculated DSCR to be the maximum DSCR value of the calculated DSCR is greater than the maximum DSCR value;
adjusting the calculated DSCR to be the minimum DSCR value of the calculated DSCR is less than the minimum DSCR value; and
recalculating the all-in spread based on the spread in the DSCR pricing grid corresponding to the maximum DSCR value.

5. The method of claim 4 wherein the loop is performed three times.

6. The method of claim 1 wherein the initial spread is calculated by:
determining a maximum LTV from the pricing grid and a minimum LTV from the pricing grid;
comparing the calculated LTV, with an average LTV defined by the minimum LTV and the maximum LTV;
defining the initial spread as the maximum LTV if the calculated LTV is greater than the average LTV; and
defining the initial spread as the minimum LTV if the calculated LTV is less than the average LTV.

7. The method of claim 1 wherein the one or more offset values comprises at least one of a property type offset, a property condition offset, a loan term offset, an overpar spread factor offset, a lease status offset, and a single tenant status offset.

8. The method of claim 1 wherein the loan payment amount is determined by multiplying the requested loan amount by a payment rate defined as the monthly interest rate plus one.

9. The method of claim 1 wherein the user is a correspondent lender obtaining the prospective loan on behalf of a borrower, and wherein the lender is a bank, a commercial lending institution, or a large-scale capital fund provider.

10. The method of claim 9 wherein the loan is a commercial real estate loan, and wherein the property is an income-generating property owned or to-be-owned by the borrower.

11. The method of claim 1 wherein the lender and user are coupled through a computer-based communications network and wherein the method further comprises the steps of:
providing an online loan application interface to the user maintained by the lender; and
prompting the user for the entry of the input data.

12. The method of claim 11 wherein the network comprises the Internet, and wherein the loan application interface is implemented as a web-based interface.

13. A distributed client-server computer system comprising:
a user client computer;
a lender server computer coupled to user client computer and configured to a receive a loan request from the user client computer;
one or more correspondent client computers coupled to the seller client computer; wherein the lender server computer executes an interactive pricing program configured to:
receive loan application information, property description information, and overpar spread factor information from the user and correspondent lender in reference to a prospective commercial real estate loan; and
iteratively calculate a debt service coverage ratio for the loan based on a net cash flow of the user divided by the loan payment amount, wherein the spread for the loan is iteratively adjusted based on offset values defined by the user input information.

14. The distributed client-server computer system of claim 13 wherein the lender server computer operated by a bank, a commercial lending institution, or a large-scale capital fund provider.

15. The distributed client-server computer system of claim 14 wherein the correspondent lender comprises a lender that agrees to finance the commercial real estate loan on behalf of the user.

16. The distributed client-server computer system of claim 14 wherein the network is the Internet, and wherein the user client computer executes a web browser program and the lender server computer executes a web server program, and further wherein the loan and property information are provided by the user through a web site operated by the lender.
